(19) United States
(12) Patent Application Publication
(10) Pub. No.: US 2010/0288380 A1
(43) Pub. Date: Nov. 18, 2010

(54) FLUID DISTRIBUTION ELEMENT FOR A FLUID-CONDUCTING DEVICE, IN PARTICULAR FOR MULTICHANNEL-LIKE FLUID-CONDUCTING APPLIANCES WHICH ARE NESTED IN EACH OTHER

(76) Inventors: Benoit Sicre, Freiburg (DE); Thore Oltersdorf, Freiburg (DE); Michael Herman, Freiburg (DE)

Correspondence Address: GAUTHIER & CONNORS, LLP, 225 FRANKLIN STREET, SUITE 2300, BOSTON, MA, 02110, US

(21) Appl. No.: 12/784,766

(22) Filed: May 21, 2010

Related U.S. Application Data
(63) Continuation of application No. PCT/EP2008/009985, filed on Nov. 25, 2008.

(30) Foreign Application Priority Data
Nov. 27, 2007 (DE) 102007056995.7

(51) Int. Cl. F15D 1/02; B23K 20/04

(52) U.S. Cl. 137/561 R; 228/115

(57) ABSTRACT

The fluid distribution element according to the invention has a very low spatial requirement and simplifies the interlinked connection of multichannel pipes for the purpose of construction of a compact assembly for heat exchange. In particular the fluid distribution element according to the invention can be produced in a constructionally simple manner thus without, as in the state of the art, an increased risk of leakage arising at the interpenetration points. In order to prevent in addition possible pressure losses, the construction of the fluid-conducting device can be effected advantageously by means of the fluid distribution elements such that bionic attachments are followed in the line of the channel.

### PRIORITY INFORMATION

This application is a continuation of PCT Application No. PCT/EP2008/009985 filed on Nov. 25, 2008, that claims priority to German Application No. 102007056995.7, filed on Nov. 27, 2007. Both applications are incorporated herein by reference in their entireties.

### BACKGROUND OF THE INVENTION

The present invention relates to a fluid distribution element for fluid-conducting devices, in particular for devices which have multichannel pipes. The fluid distribution element according to the invention is described subsequently alternatively also as distributor coupling, fluid distribution device or fluid collection device. Furthermore, the present invention relates to an arrangement comprising such fluid distribution elements and also to production methods for producing such fluid distribution elements.

Fluid distribution elements are of interest in particular if heat- or material transport between a plurality of carriers (fluids) is intended to take place simultaneously. Pipe-in-pipe heat exchangers in air-conditioning units in the automobile industry represent one example, serving as internal heat exchangers for the refrigeration cycle. In particular fulfilling requirements with respect to spatial requirement and weight reduction and also with respect to cost reduction is hereby essential. A further example in which fluid distribution elements can be used are so-called combination evaporators (also in short: combi-evaporators) for heat pumps, as are described for example in the patent specification WO 2004/094921 A1.

Production methods for pipe-in-pipe arrangements for example comprising metal or plastic material are thereby known, where the connection to the supply line or to the collecting leg is effected via penetration of the projecting channel (see e.g. DD 269205 A1). Such a production method is however multistage and not completely automatable: it requires inter alia sealing of the penetrated channel, generally by a solder, the thermal expansion behaviour of which is different from that of the channel material. With high thermal stressing, this can lead to the formation of cracks. As a result, the requirement arises for a more comprehensive leakage test which is time-consuming and labour-intensive.

Furthermore, construction principles for heat exchangers for cooling or heating liquids or gases which are configured from a plurality of metal sheets which are roll-pressed together are known from the state of the art, channels being inflated. Then plates hereby serve for separation of the fluids (for example DE 30 03 137 A1). Roll-bonding is hereby undertaken, as a result of which a connection of two or more relatively thin strips, sheets or boards is produced, which takes place by roll pressure. Such a connection can be produced for example also by heating or by glueing. Intermediate metal sheets can hereby have undulations in order to intensify the heat exchange.

Heat transfer means or heat exchangers are subdivided according to their basic shape into shell-and-tube-, plate-, coaxial- and spiral heat exchangers. A plate heat exchanger can be constructed very compactly compared with other embodiments. Because of its material requirement and total volume, it must therefore be preferred basically wherever the requirements for low material costs and compactness for small plants outweigh corrosion- and pressure resistance. This is the case for example in the field of evaporators used in refrigeration technology. In the field of heat pumps, it applies that, in addition to the costs for the plant itself, increased production costs arise due to the necessary acquisition of a heat source. For this reason, external air heat pumps are advantageous from an economy point of view. Normally, lamellar tube heat exchangers are used for this purpose in refrigeration cycles of these plants. However, the efficiency of such a heat pump is reduced because the heat source is subject to much stronger seasonally conditioned temperature variations. By assisting this primary heat source with a secondary heat source, gains can be made in the evaporator performance and less frost formation on the evaporator of an external air heat pump. For this purpose, combi-evaporator systems for example have been developed (see WO 2004/094921 A1). In all such mentioned systems, the fluid distribution element according to the invention can be used as component: as is described subsequently in more detail, this offers the advantage that, for example in the case of the combi-evaporator, arrangements of pipes which are introduced concentrically one into the other and in which the geometry has supply lines with interpenetrations, can be avoided. Such supply lines with interpenetrations are necessary in the state of the art if fluids are intended to be in direct thermal contact with each other. For this purpose, the two following possibilities for production are known from the state of the art:
1. Two pipes of a different diameter are disposed one in the other and the volume of the annular gap and that of the inner pipe are packed with sand. In this state, a typical meandering pipe arrangement (pipe register in the lamellar body) can be achieved. This method is technically very complex and not completely automatable.
2. The outer pipe is already preformed with respect to lamellae. The pipe register is then already disposed in the lamellar body. The inner pipe is now introduced into this pipe register, said inner pipe interpenetrating into the pipe register in the region of the pipe bends outwith the lamellar body. As a result, problems result in particular in automated manufacture because of the complex geometry of the interpenetrating regions of the pipe wall in the pipe bends.

### SUMMARY OF THE INVENTION

Starting from the state of the art, it is hence the object of the present invention to make available a fluid distribution element (or an arrangement of fluid distribution elements) with which, in a constructionally simple and economical manner and also in a reliable manner from the point of view of a long lifespan, a fluid distribution within a fluid-conducting device, in particular within a heat exchanger or within a device for exchanging materials between fluid flows, can be achieved. Furthermore, it is the object of the present invention to make available corresponding production methods.

The present invention is achieved by a fluid distribution element according to claim 1 and also by an arrangement of such fluid distribution elements according to claim 13. Advantageous embodiments of the fluid distribution elements or arrangements according to the invention can be deduced from the dependent claims. Methods according to the invention can be deduced from claims 17 to 19. Uses according to the invention are described by claim 20.

A fluid distribution element (and also a corresponding arrangement) is firstly described subsequently in general. Following hereon are concrete embodiments. The individual concrete constructional features, as can be deduced both from the general description and the subsequent special embodiments, can naturally hereby also be modified constructionally or used in any other, not-shown combination within the scope of the present invention by the person skilled in the art by means of his expert knowledge without the scope of the present invention which is provided solely by the patent claims being consequently exceeded.

According to the invention, a fluid distribution element or a fluid distribution device/fluid collection device, in particular made of metal or plastic material, is made available, which is suitable in particular for connection to multichannel-like lines (multichannel pipes) which nest in each other or overlap. The purpose of such multichannel pipes resides in conducting one or more different fluids separately, independently of each other, in a space-saving construction and in making use of the option of controlled heat exchange or controlled material exchange. For example multichannel tubular heat exchangers hereby offer the advantage that they make possible, within a reduced space, heat exchange between different heat carrier media (for example from two different heat sources with a different temperature level and with a different heat carrier composition and a heat sink). Multichannel pipes offer inter alia the advantage that they enable, within a reduced space, the controlled material exchange between more than two fluids, for example by means of the diffusion, osmosis or sieve principle. The present invention makes available a fluid distribution element or a distributor coupling, the purpose of which is connecting, on the one hand, single-pipe supply lines to, on the other hand, a multichannel pipe without the channels requiring to interpenetrate. The approach according to the invention resides in the individual supply line channels opening into partial channels and these partial channels intersecting and overlapping so that a contact surface is produced for the purpose of heat- and/or material exchange. The fluid distribution element or coupling can be produced advantageously from metal or plastic material and by different economical methods (for example pressure welding, glueing and/or soldering).

The fluid distribution element according to the invention has a very low spatial requirement and simplifies the interlinked connection of multichannel pipes for the purpose of construction of a compact assembly for heat exchange. In particular the fluid distribution element according to the invention can be produced in a constructionally simple manner thus without, as in the state of the art, an increased risk of leakage arising at the interpenetration points. In order to prevent in addition possible pressure losses, the construction of the fluid-conducting device can be effected advantageously by means of the fluid distribution elements such that bionic attachments are followed in the line of the channel.

As is represented subsequently in more detail with reference to the special embodiments, the fluid distribution element according to the invention has a plurality of individual layers which are disposed in a stack one above the other (for example flat metal layers or plastic material layers) which are connected respectively to each other by parts of their surfaces. Between such connection regions, bulges or raised portions are produced perpendicular to the layer plane (for example by inflated partial regions of the surfaces which have been provided with a separating means or also by preforming), which bulges or raised portions then form intermediate spaces between the individual layers by means of which fluid-conducting channels are produced. This advantageously concerns a stack arrangement comprising three material layers which are pressure-pressed for example, particularly advantageously (see also subsequent embodiment) four material layers are used.

As already mentioned, along specific paths on the separation surfaces between two individual layers, these areas are not joined, for example by inserting a separation means, but are widened via a pressure fluid (this can take place with the help of the known roll-bonding method for channel formation, cf. DE 30 03 137 A1). As a result, channels are produced between the various layers and are guided such that they form, in the edge regions of the body on the one end-side, separate connections for single-pipe supply lines, converge in the course of the body until they intersect and overlap so that channels which nest in each other or overlap and to which then a multichannel pipe can be connected on the other end-side of the body are produced.

In addition to the economical production with the help of the described roll-bonding method with metal sheets, such a fluid-distribution element according to the invention can be produced economically and in a fully automated manner even by means of glueing of prefabricated plastic material or metal parts in which half-channels are already prefabricated.

A fluid distribution element according to the invention is hence, in the simplest case, a structure with essentially circular or semicircular flow cross-sections (pipes) which are pre-embossed into flat bodies (the individual layers) which are glued or soldered in this variant to other flat bodies. In the edge regions or at the end-sides of these flat bodies, the pipe connection pieces which are connected to the supply lines in a form fit extend. In the region of the connection of the individual pipe lines, the channels do not overlap in or between the individual layers.

For the previously described roll-bonding method (or the autogenous roll welding), individual layers made of metal are used. A suitable separation means is applied at the places of the channels to be formed and the metal sheets are cold-welded to each other by rolling. The separation means allows non-joined regions to exist which can be widened to form pipes by the application of pressure with a fluid, in particular air. According to the invention, there are several possibilities for the sequence of expansion of the non-joined regions: for example, firstly the space between the inner, central individual strata or individual layers is widened, thereafter the space between individual layers situated further out. In order to retain the channel structure of already inflated channels, it is possible to leave these under pressure if further channels are being inflated. The individual channels of the fluid distribution element or distributor coupling can easily be connected to each other and subsequently individual fluid distribution elements or distributor couplings can be stacked perpendicular to the layer plane and connected to supply lines so that a stack (arrangement) comprising joined, layered fluid distribution elements provided with fluid-conducting channels is produced. The construction of such an arrangement of fluid distribution elements according to the invention can then be configured similarly to a lamellar heat exchanger, in which the pipes form a closed body with the lamellae. In this way, an arrangement of fluid distribution elements or a multiple fluid-conducting assembly using a plurality of fluids can be formed according to the invention, a for example gaseous fluid being able to flow between the individual fluid distribution elements (layered from individual layers) or around the individual fluid distribution elements which are disposed at a spacing from each other in the stack and serve now as lamellae. Between adjacent individual fluid distribution elements or plate bodies, spacers can thereby be disposed, which can be chosen such that sufficient fluid can flow through or pass between individual fluid distribution elements. On the outer surfaces of the fluid distribution elements according to the invention, surface structures such as burrs or ribs which have a turbulence-increasing effect can hereby be applied. This leads to improved heat exchange between a fluid flowing in a fluid distribution element according to the invention and the fluid flowing through between this and an adjacent fluid distribution element.

The previously described mode of production for the individual fluid distribution elements or the entire fluid-conducting assembly which has the arrangement of fluid distribution elements offers, in addition to the advantage that no soldering or welding operations are necessary, also the advantage that they or it can be produced with the same conventional economical metals or plastic materials as the multichannel pipes themselves which are to be connected. The connections on the end-side of the individual pipe supply lines are advantageously shaped with a circular cross-section and chosen with a standard inner width so that a connection to conventional lines and male fittings can be effected without difficulty. The cross-section of the channels can remain constant along the stretch so that pressure or throughflow remain constant or are varied so that physical phenomena, such as e.g. evaporation or condensation, can be assisted specifically. The distributor coupling or fluid distribution element according to the invention is hence characterised by a simple construction and simple production and also by low material costs. The shape of the plates can be arbitrary (viewed in the layer plane), for example in a rectangular shape or even in a polygonal shape.

The fluid distribution element according to the invention can be used particularly advantageously in a combination evaporator: the entire combi-evaporator is then hereby manufactured, not conventionally as a lamellar tube heat exchanger made of aluminium lamellae and pipe registers made of copper, instead a multilayer body comprising at least four individual layers is produced (for example with the previously described roll-bonding method). According to the production method (soldering, roll-bonding or rolling, welding or glueing), specific regions in the intermediate layers or between the individual layers can remain free of joining connections by means of separation means or recesses, which can be inflated after joining the other regions or are already pre-embossed during the joining and hence form regions between the individual layers for the throughflow of fluids (i.e. channels). The exception here is production by extrusion, structures without branches and runbacks being able to be produced from one piece. In the other production methods, the regions subjected to a flow in the intermediate layers can also include more complex structures, such as branches and runbacks.

As already described previously, the construction is simplified also when using the fluid distribution element according to the invention in the combi-evaporator such that supply lines are no longer complex shapes with interpenetrations, instead the problem of the interpenetrations is moved to the multilayer bodies. On the side of the multilayer body, the bodies subjected to a flow concern then pipe-like channels or channel-like pipes. The multilayer plates are shaped such that a functionality analogous to the combi-evaporator is achieved, which is achieved in that a body with advantageously four layers is cold-welded together on plates for example in roll-bonding technology. As a result, in total three intermediate layers or regions between two adjacent individual layers are produced, which are available for the fluid conduction, either by means of separation means or by the use of pre-embossed structures. However, the individual layers can also be soldered or glued, recessed regions then representing guidance channels. The upper and the lower layer of this multilayer body can then be used for the production of a channel system overlapping in the flow lines. These external channel systems can hereby be separated from each other also by two further plates, which can be necessary since, during the later continuations of these channels, the channel in the central intermediate layer interpenetrates laterally into the external channels. This process of lateral interpenetration corresponds to interpenetration in the previous production of supply lines or distributor lines.

According to the same principle as previously described, also Y-shaped branches can be produced. Such a Y-shaped branch part which can be used in combination with a fluid distribution element according to the invention or can be connected to the latter is used if for example a multichannel pipe must be divided into two parallel multichannel pipes (for example for the purpose of reducing the pressure drop in the case of the same exchanger area in combi-evaporators). In order to produce such a Y-shaped element, for example a separation medium can be applied on the layer planes according to the shape and arrangement of the branch. As in the case of the coupling according to the invention, the for example four individual layers can then be roll-pressed and the channels can subsequently be inflated.

The present invention hence makes available a distributor coupling made of metal or plastic material for multichannel-like fluid-conducting appliances which nest in each other or overlap, which distributor coupling essentially comprises separate supply lines on the one side (first end-side) and channels nesting in each other on the other side (second end-side opposite the first end-side), the channels not interpenetrating but opening into separate partial channels (connected to the multichannel pipe), these partial channels intersecting and partially or completely overlapping so that a contact surface for heat- or material transport is produced via an intermediately situated channel wall. The supply or discharge of the fluids to or from the heat exchanger can be effected in separate, non-overlapping channels in order that the supply line can be connected on one side to conventional single-pipe lines. The element according to the invention can be produced by roll-bonding or pressure welding from a plurality of individual layers (advantageously at least three or four individual layers). The channel-like structures can be produced by inflation. The channel-like structures can however also be made available alternatively by pre-embossed channel structures in the individual layers. The individual layers can also be cast or connected to each other by glueing. A plurality of fluid distribution elements according to the invention can be stacked preferably one above the other perpendicular to the layer plane and at a spacing from each other, as a result of which a heat exchanger with a plurality of multiple channel pipes or multiple lengths is produced within the fluid-conducting assembly. Between each individual fluid distribution element of such a fluid-conducting assembly, a further fluid can then flow through corresponding fluid-conducting structures. When establishing the channel path of the individual channels in the fluid-conducting assembly, bionic projections (for example harp-shaped) can then be produced for the purpose of reducing the pressure loss. With the described production methods, pipe branches (e.g. Y-shaped branches) can also be produced. In the case of a phase change, the cross-sections of channels introduced one into the other can be adapted to each other for the purpose of a constant volume flow.

The present invention is now described subsequently with reference to individual embodiments.

### DETAILED DESCRIPTION OF THE ILLUSTRATED EMBODIMENTS

There are shown:

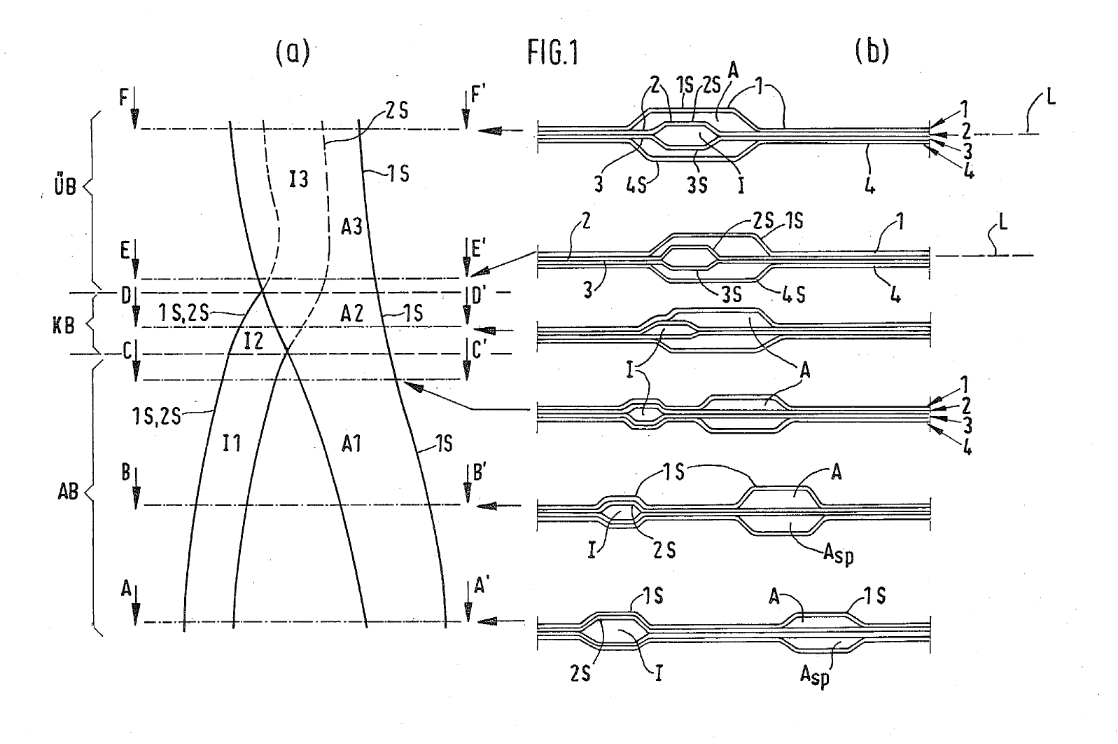

FIG. 1 a first fluid distribution element according to the invention in a view on the layer plane L (FIG. 1a) and in sectional view perpendicular to the layer plane L (FIG. 1b).

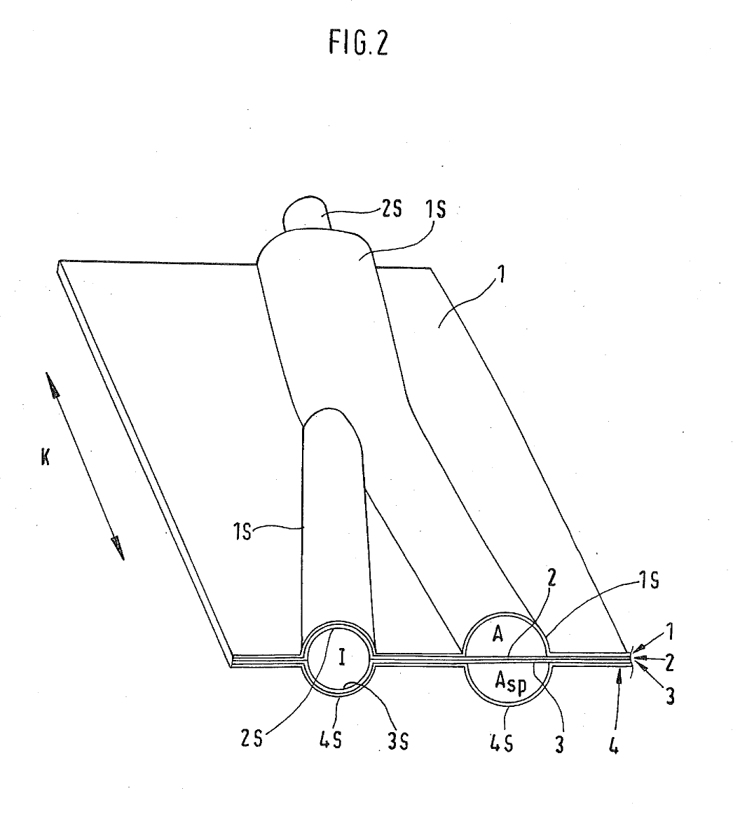

FIG. 2 an isometric view of the fluid distribution element according to the invention represented in FIG. 1.

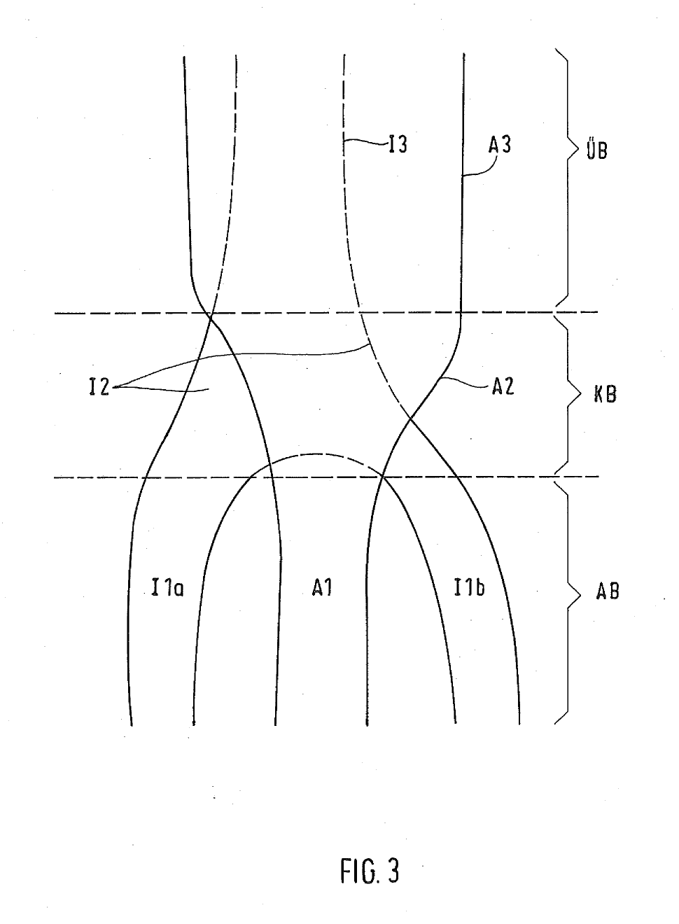

FIG. 3 a second fluid distribution element according to the invention which is constructed analogously to the one shown in FIG. 1, however forming a branched inner channel.

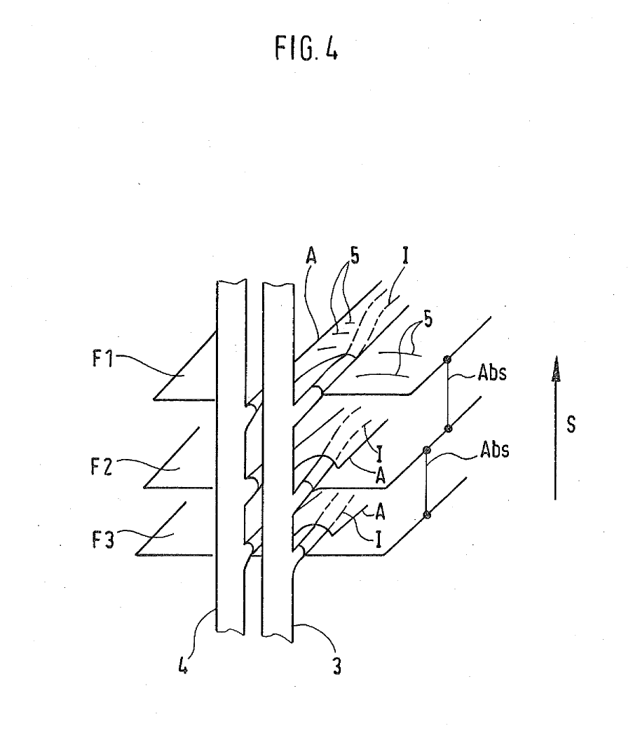

FIG. 4 an arrangement of a plurality of fluid distribution elements according to the invention stacked one above the other.

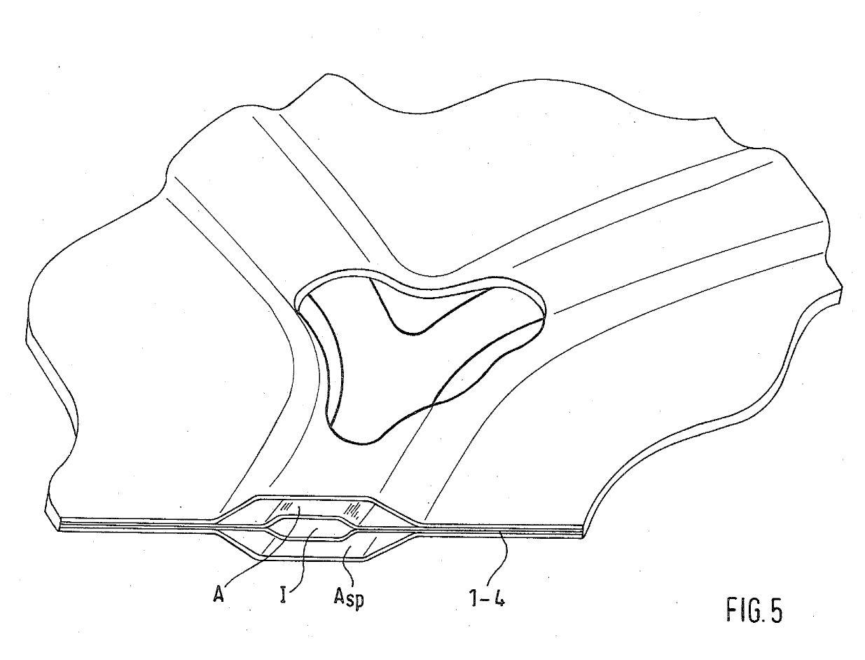

FIG. 5 a Y-shaped fluid distribution part which can be connected to a fluid distribution element according to the invention.

FIG. 1 shows an embodiment of a fluid distribution element according to the invention. FIG. 1a shows a view on the layer plane L of the fluid distribution element, FIG. 1b shows different sectional views perpendicular to the layer plane and essentially perpendicular to the channel longitudinal direction. K (cf. FIG. 2). The channel longitudinal axis direction is hereby that direction in the layer plane L which essentially corresponds to the flow direction of the fluid through the inner channel I or the outer channel A.

The fluid distribution element comprises four single layers or individual layers 1 to 4 which respectively comprise flat metal bodies, here zinc sheets or aluminium sheets. The individual aluminium sheet layers or zinc sheet layers 1 to 4 are stacked one above the other perpendicular to the layer plane L. Parts of the surfaces or the upper sides and/or undersides of the individual layers 1 to 4 are respectively connected in a pressure tight manner by the previously described roll-bonding method or roll-pressing to parts of the oppositely situated surfaces of adjacent individual layers. Between these connected partial surface regions of two layers, non-connected regions respectively are configured, as described subsequently in more detail, in which regions cavities are produced by curving one or both of the adjacent individual layers if they are then configured as fluid-conducting channels (inner channel I and outer channel A, A_{SP}, see subsequently).

As FIG. 1 shows, a first channel structure 1S which is curved upwards in the direction perpendicular to the layer plane L is formed in the uppermost individual layer 1. In the first intermediate layer (upper intermediate layer 2) disposed adjacent to the uppermost layer 1, a further channel structure, the second channel structure 2S, which is curved upwards perpendicular to the layer plane L is formed. Viewed in the direction of the channel longitudinal direction K (in FIG. 1a, the direction from below to above, cf. FIG. 2), the two channel structures 1S and 2S are now configured in different regions of the individual layers, as described subsequently in more detail, such that firstly two separately extending channels, inner channel I and outer channel A, are configured, which converge increasingly viewed in the channel longitudinal direction K, finally intersect and partially overlap and finally extend essentially parallel to each other and completely overlapping one above the other.

FIG. 1a at the bottom on the left shows for this purpose the connection region AB, on the outside end-side of which (the side shown at the bottom in FIG. 1a) the inner channel I and the outer channel A extend completely separately from each other and laterally offset relative to each other so that, on this end-side, two separate individual pipes can be connected to the fluid distributor according to the invention. As the sectional view A-A′ shows (FIG. 1b at the bottom on the right), the channel structure 1S of the uppermost layer 1, on the outside end-side of the connection region AB, is formed in the shape of two bulges formed laterally offset relative to each other. In the region of the one bulge (the bulge shown at the very bottom on the left in FIG. 1b), the individual layer 2 situated thereunder likewise has a bulge (which forms the channel structure 2S) which is configured and disposed such that it nests in a form fit into the bulge 1S of the first layer I. In the region of the second bulge part of the channel structure 1S (FIG. 1b at the very bottom on the right), the individual layer 2 situated thereunder has however no bulge but is configured as a flat surface: as a result, a cavity which is trapezoidal in the illustrated cross-section and tapers upwards is configured between the individual layers 1 and 2, said cavity being formed as first outer channel partial piece A1 of an outer channel A configured for the fluid transport.

The third individual layer 3 which is disposed abutting against the second individual layer 2 and below the same is now formed mirror-symmetrically relative to the second individual layer 2, viewed relative to the layer plane L. The fourth individual layer which is disposed abutting against this third individual layer 3 and below the same is formed mirror-symmetrically (viewed relative to the layer plane L) relative to the uppermost individual layer 1. Because of this mirror-symmetrical formation (and a corresponding mirror-symmetrical arrangement), there is produced in the connection region AB, by the curved channel structure 2S of the second individual layer 2 and by its flat shape in the third individual layer 3, a cavity, which is approximately double-trapezoidal in cross-section, between the second individual layer 2 and the third individual layer 3 which is configured as inner channel I (in the region AB as first inner channel partial piece likewise for fluid conduction. Because of the previously described symmetrical configuration there is produced furthermore, viewed relative to the layer plane L, situated opposite the first outer channel partial piece A1 of the outer channel A between the fourth layer and the third layer, a cavity which is likewise approximately trapezoidal in cross-section and which is configured as further outer channel A_{SP} (SP hereby stands for mirror-symmetrical).

As now the further cross-sections B-B′ and C-C′ show, which were taken at a spacing from the cross-section A-A′, viewed in the channel longitudinal direction K, the spacing of the channel centres of the first inner channel partial piece I1 and of the first outer channel partial piece A1 of the inner channel I or of the outer channel A, viewed in the channel longitudinal direction K, reduces successively so that the two channels I and A (or A_{SP}) converge successively until they begin to intersect in the intersection region KB abutting on the connection region AB in the channel longitudinal direction K.

In the intersection region KB, the first channel structure 1S of the uppermost layer and the second channel structure 2S of the upper central layer 2 are now configured such (this applies likewise to the third channel structures 3S and 4S of the lower central layer 3 and of the lower layer 4 which are situated opposite them minor-symmetrically) that the overlapping region between the first channel structure 1S and the second channel structure 2S enlarges increasingly and in fact until (because of the greater width of the channel structure 1S in comparison with the channel structure 2S; the width is hereby the extension perpendicular to the direction K in the layer plane L) the first channel structure 1S completely overlaps the second channel structure 2S. In the intersection region KB, the first channel structure 1S, viewed in the channel longitudinal axis direction K upwards (cf. FIG. 1A), is hence displaced successively over the second channel structure 2S so that the second channel partial pieces (partial piece A2 of the outer channel A and partial piece 12 of the inner channel) which successively are displaced one over the other are configured. At the upper edge of the intersection region KB, the first channel structure 1S overlaps the second channel structure 2S completely. The sectional view D-D′ shows a section in the region of a still partial overlap.

At the upper end of the intersection region KB, the overlapping region ÜB then abuts, in which region third channel partial pieces (third inner channel partial piece I3 and third outer channel partial piece A3) are configured such that the inner channel I or the second channel structure 2S is overlapped or covered completely by the outer channel A or by the first channel structure 1S. At the upper edge of the overlapping region ÜB (upper end-side of the fluid distribution element), the first channel structure 1S overlaps the second channel structure 2S symmetrically on both sides so that the inner channel I, 13 extends centrally below the outer channel A, A3 or is surrounded on half a side by the latter. The same of course applies correspondingly to the further outer channel A_{SP} which is disposed symmetrically relative thereto.

At the upper end-side, the illustrated fluid distribution element hence has an inner channel I which essentially runs concentrically within two outer channels A, A_{SP} so that a correspondingly configured multichannel pipe can be connected in a simple manner to this upper connection side (cf. also sectional view F-F′).

As is clear to the person skilled in the art, the illustrated embodiment of a fluid distribution element can be varied within the scope of the present invention in many ways: thus, instead of the configuration of a connection piece for a multichannel pipe in the region of the upper connection side, the fluid distribution element can be configured or continued integrated with such a multichannel pipe. In addition, the most varied of fluid-conducting structures can be integrated in the illustrated fluid distribution element, thus e.g. a Y-shaped branch element (cf. also FIG. 5) in which the inner channel I which is guided concentrically within the two outer channels A, A_{SP} including the outer channels surrounding it is branched into two separate legs.

Likewise, it is also possible to configure the fluid distribution element according to the invention from merely three individual layers 1 to 3 so that merely one outer channel A and one inner channel I are produced (omission of the second outer channel A_{SP}). The further layer elements 3 and 4 also need not be formed symmetrically relative to the layer elements 1 and 2 but can also be configured as flat plates. In this case, there are produced merely an inner channel I which is simply trapezoidal here in the example (in general however also other forms are possible) and an outer channel A.

Alternatively to the configuration comprising a plurality of originally separated elements, the individual layers can equally also be configured in one piece (for example by means of an extrusion method). This need not concern all individual layers but can concern also only individual ones of the illustrated individual layers (thus for example dispensing with the individual layer 4, the two individual layers 2 and 3 could be produced as a one-piece, extruded moulded article, a further layer (uppermost layer 1) being superimposed).

In the illustrated example, the underside of the uppermost layer 1 and also the upper side of the upper central layer 2 hence form the wall of the outer channel A, the underside of the layer element 2 and also the upper side of the layer element 3 form the outer wall of the inner channel I and also the underside of the layer element 3 and also the upper side of the layer element 4 form the wall of the lower outer channel A_{SP}.

FIG. 2 shows an isometric view of the fluid distribution element represented in FIG. 1. In the front section shown at the bottom, the two separate outer channels A and A_{SP} (semicircular) and also the inner channel I (circular) can be clearly detected.

FIG. 3 shows a further embodiment of a fluid distribution element according to the invention (only the view on the layer plane L shown here). This is basically constructed just like the layer element shown in FIG. 1 so that only the differences are described here. In the example shown in FIG. 3, the two channel structures 1S and 2S are configured such that, in the connection region AB and in the intersection region KB, the inner channel I is separated into two separate inner channel partial pieces: in the connection region AB, hence two separate first inner channel partial pieces I1a and I1b which are configured offset relative to each other and offset relative to the outer channel A, A1 are configured and permit the connection of two separate individual pipe supply lines for the inner channel I on the outer end-side. The two separate inner channel partial pieces intersect in the intersection region KB hence on both sides of the outer channel A and below the same into the latter, which can be produced by a corresponding construction as described already with reference to FIG. 1. As in the case shown in FIG. 1, the inner channel I, 13 and the outer channel A, A3 extend overlapping one above the other in the overlapping region ÜB.

FIG. 4 shows an arrangement according to the invention comprising a plurality of (here three) fluid distribution elements F1 to F3. The three fluid distribution elements F1 to F3 are hereby disposed at a spacing from each other and one above the other perpendicular to the layer plane or in the stack direction S. The layer planes L of the individual fluid distribution elements hereby extend parallel to each other. The individual fluid distribution elements are maintained at a spacing from each other by spacers Abs. At the front, the connection side for the individual pipe supply lines for the fluid distribution elements is shown in FIG. 4. The individual pipe supply lines are produced here such that, from a first connection line 3 disposed in the stack direction S at the level of the individual fluid distribution elements, respectively individual pipe channels branch off and then are connected respectively to an inner channel I of a fluid distribution element. A second connection line 4 is disposed parallel to the first connection line 3 and likewise laterally offset therefrom in the stack direction S, from which second connection line individual pipe channels likewise branch off at the level of the individual fluid distribution elements, which individual pipe channels are then connected respectively to the individual single pipe connections of the outer channels A of the fluid distribution elements.

The illustrated arrangement is produced here, because of the spacing of the individual fluid distribution elements F1 to F3 produced by means of the spacers Abs, such that a volume is produced between two adjacent fluid distribution elements, through which likewise a fluid (third fluid outwith the inner channels I and the outer channels A) can flow. In order to ensure an optimal heat exchange here between this third fluid and the fluids flowing through the inner and outer channels, the outer surface (upperside of the individual layers 1 and underside of the individual layers 4) is provided with a large number of individual rib structures 5 which extend parallel to each other and offset relative to each other. These rib structures are disposed both laterally next to the channel structures 1S or 4S and on the latter on the outside and ensure turbulence of the third fluid flowing through the intermediate spaces between the fluid distribution elements, as a result of which the heat exchange is optimised.

Finally, FIG. 5 illustrates a Y-branching part which is produced from the individual layers 1 to 4 for example by roll-bonding and which can be used in combination with a fluid distribution element according to the invention in order to split the fluid flow of the inner channel I and of the outer channel A respectively into two separate fluid flows (the illustrated Y-branching part can be linked for example to the upper end-side of the overlapping region ÜB of the fluid distribution element according to the invention shown in FIG. 1, see there sectional view F-F′).

What is claimed is:

1. A fluid distribution element for a fluid-conducting device, in particular for a heat exchanger or a device for exchanging materials between fluid flows, having a plurality of individual layers disposed in a stack one above the other, at least one partial region of the surface of each of the plurality of individual layers being disposed abutting against at least one partial region of the surface of another individual layer of the plurality of individual layers and there being configured, at least in a first individual layer of the plurality of individual layers, a first channel structure which is curved perpendicular to the layer plane and, in a second individual layer of the plurality of individual layers, adjacent to the first individual layer, a second channel structure which is curved perpendicular to the layer plane, and the two channel structures, viewed in the channel longitudinal direction
firstly forming, in a connection region, two first channel partial pieces (first inner channel partial piece, first outer channel partial piece) of an inner channel configured for fluid transport and an outer channel configured for fluid transport, which first channel partial pieces extend separately in the layer plane offset laterally relative to each other and at a spacing from each other,
subsequently forming, in an intersection region abutting against the connection region, two second channel partial pieces (second inner channel partial piece, second outer channel partial piece) of the inner channel and of the outer channel, which two second channel partial pieces intersect in the layer plane and are displaced increasingly one over the other and connected to the first channel partial pieces and
finally forming, in an overlapping region abutting against the intersection region, two third channel partial pieces (third inner channel partial piece, third outer channel partial piece) of the inner channel and of the outer channel, which two third channel partial pieces extend essentially parallel to each other in the layer plane and are connected to the second channel partial pieces, the third inner channel partial piece being covered in an overlapping manner in the overlapping region by the third outer channel partial piece.

2. The fluid distribution element according to claim 1, wherein the first channel structure forms a part of the wall of the outer channel and a section surrounding a part of the wall of the inner channel in at least a part of the connection region and/or in that the second channel structure forms a part of the wall of the inner channel in at least a part of the connection region.

3. The fluid distribution element according to claim 1, wherein the first channel structure forms a part of the wall of the outer channel and a section surrounding a part of the wall of the inner channel in at least a part of the intersection region and/or in that the second channel structure forms a part of the wall of the inner channel and a part of the wall of the outer channel in at least a part of the intersection region.

4. The Fluid distribution element according to claim 1, wherein the first channel structure forms a part of the wall of the outer channel in at least a part of the overlapping region and/or in that the second channel structure forms a part of the wall of the inner channel and a part of the wall of the outer channel in at least a part of the overlapping region.

5. The fluid distribution element according to claim 1, wherein at least three, preferably precisely three individual layers disposed one above the other: the first individual layer as uppermost layer, the second individual layer as central layer which is disposed abutting thereon at least partially and a third individual layer which is disposed on the oppositely situated side of the uppermost layer abutting at least partially against the central layer as lower layer, preferably as lowermost layer, in which third individual layer preferably a third channel structure which is curved perpendicular to the layer plane is configured.

6. The fluid distribution element according to claim 1, wherein the third individual layer, viewed with respect to a plane parallel to the layer plane, is formed and/or disposed essentially mirror-symmetrically relative to the second individual layer.

7. The fluid distribution element according to claim 1, wherein at least four, preferably precisely four individual layers: the first individual layer as uppermost layer, the second individual layer as first central layer which is disposed abutting thereon at least partially, a third individual layer which is disposed on the oppositely situated side of the uppermost layer abutting at least partially against the first central layer as second central layer and a fourth individual layer which is disposed on the oppositely situated side of the first central layer abutting at least partially against the second central layer as lower layer, preferably as lowermost layer, in which fourth individual layer preferably a fourth channel structure which is curved perpendicular to the layer plane is configured.

8. The fluid distribution element according to claim 7, wherein the fourth individual layer, viewed with respect to a plane parallel to the layer plane, is formed and/or is disposed essentially mirror-symmetrically relative to the first individual layer.

9. The fluid distribution element according to claim 1, wherein the two channel structures form, in the connection region, a plurality of first inner channel partial pieces of the inner channel which extend separately in the layer plane offset laterally relative to each other and relative to the first outer channel partial piece of the outer channel and at a spacing from each other and from the first outer channel partial piece of the outer channel, the plurality of first inner channel partial pieces uniting in the abutting intersection region into the second inner channel partial piece.

10. The fluid distribution element according to claim 1, wherein at least a partial portion of a wall configured by the first and/or the second channel structure is configured to be selectively permeable for material exchange between the inner and the outer channel and/or for material exchange between the inner and/or the outer channel and the surroundings.

11. The fluid distribution element according to claim 1, wherein several or all of the individual layers are configured in one piece, in particular as a one-piece moulded article.

12. The fluid distribution element according to claim 1, wherein at least one of the individual layers is configured at least partially from metal or has this and/or in that at least one of the individual layers is configured at least partially from plastic material or has this.

13. An arrangement comprising a plurality of fluid distribution elements which are in a stack one above the other essentially perpendicular to the layer plane, according to claim 1.

14. The arrangement according to claim 13, wherein a first connection line which is connected respectively in the connection region to a plurality of first inner channel partial pieces of inner channels of different fluid distribution elements and/or a second connection line which is connected respectively in the connection region to a plurality of first outer channel partial pieces of outer channels of different fluid distribution elements.

15. The arrangement according to claim 13, wherein at least one multichannel pipe which is connected in the overlapping region of at least one fluid distribution element to the outer channel thereof and the inner channel thereof.

16. The arrangement according to claim 13, wherein at least one outer surface of at least one of the fluid distribution elements has a surface structure at least in portions which has preferably a rib-shaped and/or burr-shaped configuration.

17. A method for producing a fluid distribution element according to claim 1, a plurality Of individual layers of the fluid distribution element to be stacked one above the other being welded to each other by pressure-pressing by means of rollers (roll-bonding) wherein at least one inner channel and at least one outer channel of the fluid distribution element is inflated by application of pressure, in particular by means of compressed air, or in that at least one inner channel of the fluid distribution element is inflated by application of pressure, in particular by means of compressed air, and in that, in order to form at least one outer channel, at least one individual layer provided with a prefabricated channel structure is used.

18. The method according to claim 17, wherein firstly at least one inner channel is inflated before subsequently at least one outer channel is inflated or vice versa.

19. The method according to claim 17, wherein an already inflated inner channel and/or an already inflated outer channel is left under pressure, whilst a further inner channel and/or outer channel is inflated.

20. The use of a fluid distribution element or of an arrangement comprising a plurality of fluid distribution elements according to claim 1 in a heat exchanger or in a device for exchanging materials between fluid flows.
